(19) United States
(12) Patent Application Publication
(10) Pub. No.: US 2006/0096319 A1
(43) Pub. Date: May 11, 2006

(54) Analytical system and method for measuring and controlling a production process

(76) Inventor: Joop Dalstra, Haren (NL)

Correspondence Address: Charles Berman;Greenberg Traurig, 2450 Colorado Avenue, Suite 400E, Santa Monica, CA, 90404, US

(21) Appl. No.: 10/524,454

(22) PCT Filed: Jul. 30, 2003
(86) PCT No.: PCT/NL03/00547

§ 371 Date: Oct. 27, 2005

(30) Foreign Application Priority Data
Jul. 30, 2002 (NL) 1021182

(51) Int. Cl. C03B 9/41

(52) U.S. Cl. 65/29.11; 65/158; 65/29.21

(57) ABSTRACT

An analytical system for analysing and controlling a shaping process for glass products is described. The analytical system comprises an infrared-sensitive measurement system and a processor communicating therewith, the infrared-sensitive measurement system being equipped to measure infrared radiation originating from hot glass products immediately after the shaping process for the glass products and the processor being equipped to determine a heat distribution in the glass products on the basis of information determined by the measurement system. Because the infrared-sensitive measurement system is sensitive only to radiation in the so-called Near Infra Red (NIR) region, radiation originating from the interior of the glass wall can be measured. This makes novel analytical methods possible with which, inter alia, a distinction can be made between a change in glass wall thickness and a change in temperature.

The present invention relates to an analytical system for analysing and controlling a production process for glass products, the production process comprising a shaping process and a cooling process and the analytical system comprising an infrared-sensitive measurement system and a processor communicating therewith, the infrared-sensitive measurement system being equipped to measure infrared radiation originating from hot glass products immediately after a shaping process for the glass products and the processor being equipped to determine a heat distribution in the glass products on the basis of information determined by the measurement system.

A system of this type is disclosed in the patent EP 643 297 A1. This patent describes an analytical system that can be used to determine the quality of glass products before the glass products have cooled. The quality of the products is determined by determining the heat distribution in a product and comparing this with a reference heat distribution from a mathematical model. If a specific product does not meet specific criteria, this product is removed from the production process before it has cooled. In this way it is possible to use additional information from the glass shaping process, which would be lost during a cooling process, to determine the cause of a production fault. By this means it is possible to adjust the shaping process in good time, if necessary.

A disadvantage of this infrared measurement system is, however, the very low sensitivity to changes in temperature, glass purity and glass thickness in the interior of the glass wall. Specifically, glass is completely opaque to the major proportion of the infrared spectrum since the glass has a high coefficient of absorption for infrared radiation. As a result the infrared radiation from the interior of the glass wall is completely absorbed. Thus, only the infrared radiation originating from a thin surface layer is measured. Consequently, changes in the interior of the glass wall beneath this surface layer cannot be determined. The infrared radiation from the surface layer as it were blinds the infrared sensors to the small amount of radiation that originates from the interior of the glass wall. Partly because of this it is impossible to determine whether the change in the infrared radiation is caused by a change in glass wall thickness or by a change in the temperature of the glass wall. Specifically, an increase in the intensity of the infrared radiation signifies a higher temperature of the glass surface on the outside of the product. This can be caused by a thicker glass wall, as a result of which the product cools less rapidly, or it can be caused because the temperature of the product is higher. Since only the radiation from the glass surface is measured using infrared, it is not possible to distinguish between these two causes.

One aim of the present invention is to be able to measure infrared radiation originating from the interior of the glass wall of hot glass products.

In order to achieve this aim, the present invention relates to an analytical system of the type mentioned in the preamble, characterised in that the infrared-sensitive measurement system is sensitive only to radiation in the so-called Near Infra Red (NIR) region.

Infrared light with long wavelengths is completely absorbed in the interior of the glass wall. This is not the case with NIR radiation. NIR radiation essentially originates from the interior of the glass wall and the measured amount of NIR radiation is thus correlated to the amount of heat in the interior of the glass wall.

Preferably, the infrared-sensitive measurement system is sensitive to wavelengths of between 900 and 2800 nanometres. It has been found that optimum results are obtained at these wavelengths.

In one embodiment of the invention the measurement system comprises at least one infrared sensor and at least one Near Infra Red filter. Preferably, the transmission characteristic of the Near Infra Red filter is dependent on the colour and the specific material composition of the glass products. This ensures optimum measurement sensitivity.

In a preferred embodiment the processor is equipped to carry out the following steps:
(a) subdividing an image of the glass products into at least two measurement regions;
(b) determining average intensity values for the different measurement regions for consecutive glass products;
(c) determining, for at least two measurement regions, a current average value from the average intensity values determined for a number of consecutively shaped glass products over time;
(d) recording, for each of the at least two measurement regions, any deviation between the current intensity or the current average intensity and a reference value;
(e) comparing any deviations between the at least two measurement regions;
(f) generating an error signal in the event of any deviations.

By analysing the deviations between the at least two measurement regions it is possible to determine whether a change in glass wall thickness has occurred or whether a change in temperature has occurred. In this context change signifies a change with respect to the previous glass products and glass products produced in the past

In another embodiment the processor is equipped to carry out the following steps:
(a) subdividing an image of the glass products into at least two measurement regions;
(b) determining average intensity values for the different measurement regions for consecutive glass products;
(c) determining a machine plot by plotting a graph of the average intensity values as a function of the consecutive glass products, i.e. stations;
(d) determining a cooling plot by means of an optimum fit curve;
(e) recording any deviations between a current machine plot and the cooling plot;
(f) generating an error signal in the event of any deviations.

By determining an optimum fit curve and taking this as reference curve, current machine plots can be compared with this. This can be performed individually for each measurement region. Deviations in the machine plots compared with the fit curve provide information on errors in the shaping process. By means of this analytical method both the quality of the shaping process and also the quality of the glass products can be monitored. If the measured intensities are precisely on the cooling plot, the glass products will have the same quality.

In another embodiment the processor is equipped to record local discontinuities in the heat distribution in a glass product. With the aid of this analytical system the heat distribution of the heat from the interior of the glass wall can be determined. If material foreign to glass, glass of a different composition, a lower amount of glass (blister, air bubble) or a higher amount of glass (glass fragment or glass point) is present in the glass wall this will result in a local discontinuity in the heat distribution. Such a local discontinuity is the result of a change in the purity of the glass.

Furthermore, the present invention relates to a method for analysing and controlling a shaping process for glass products, as described in claim 13. By measuring radiation in the Near Infra Red region the heat distribution in the interior of the glass wall can be determined, which offers possibilities for novel analytical methods.

One embodiment of the abovementioned method is described in claim 18. Although the intensity of the measured radiation is dependent on the temperature distribution, the amount of glass and the material properties, changes in the thickness of the glass wall can readily be determined by means of this method. By comparing the deviations from average intensities in two measurement regions it is possible to determine whether the change in the measured radiation is to be ascribed to a change in the thickness of the glass wall or to a change in the temperature of the glass. This analytical method will be explained in more detail in the description of the figures.

Another embodiment of the method according to the invention is described in claim 21. With the aid of this method the correct settings for the shaping process can rapidly be determined and a setup time in the case of a change in production is shortened. Moreover, deviations in the current machine plots for the different measurement regions can be used to analyse faults in individual sub-processes of the shaping process.

Further advantages and characteristics of the present invention will become clear on the basis of a description of a number of embodiments, reference being made to the appended drawings, in which:

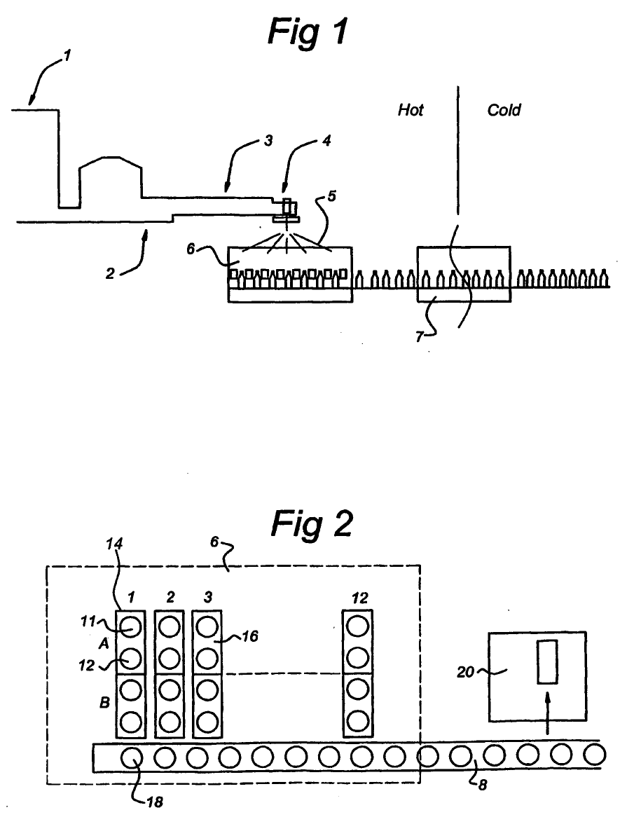

FIG. 1 shows a production process from the state of the art,

FIG. 2 shows, diagrammatically, a glass shaping machine and a measurement system from the state of the art,

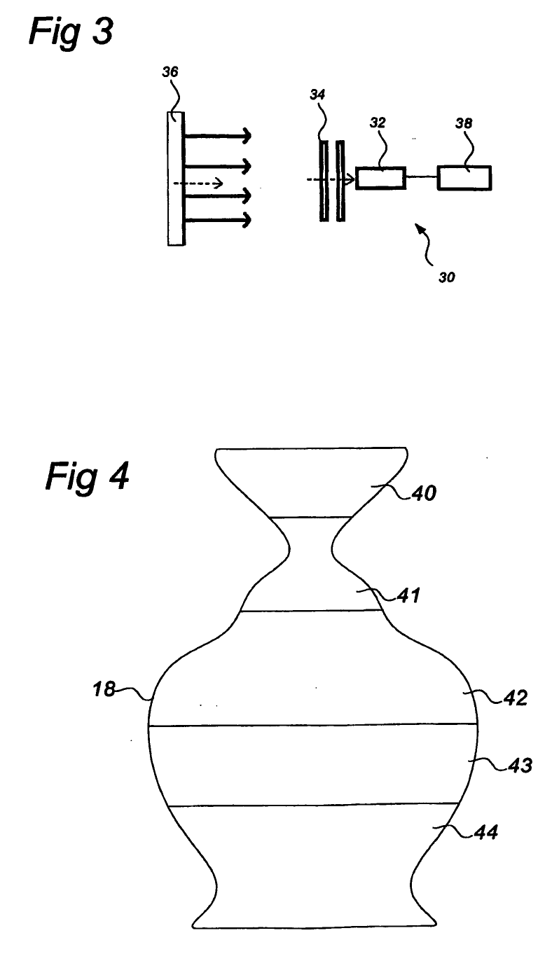

FIG. 3 shows, diagrammatically, a measurement system according to the invention,

FIG. 4 shows an example of a subdivision of the glass products into measurement regions.

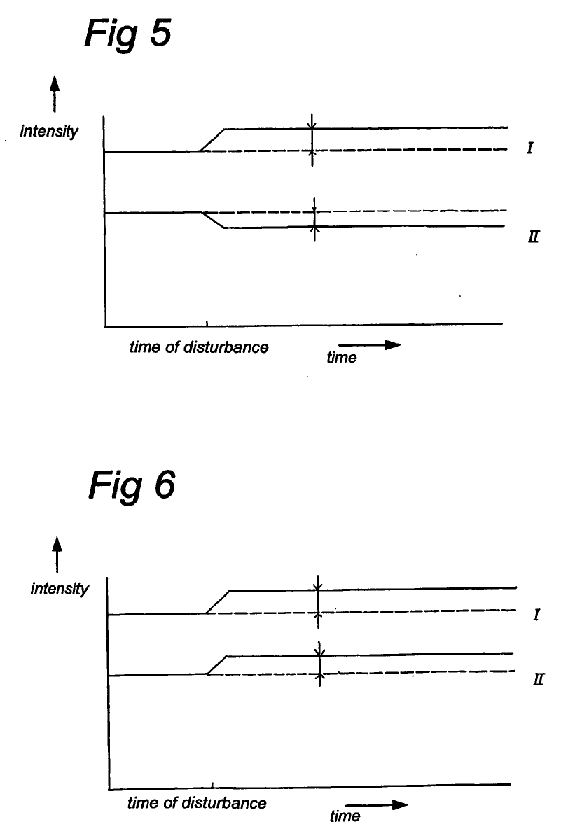

FIG. 5 is a graph showing the change in the average intensity of two measurement regions and a reference value,

FIG. 6 is a graph showing the change in the average intensity of two measurement regions and a reference value,

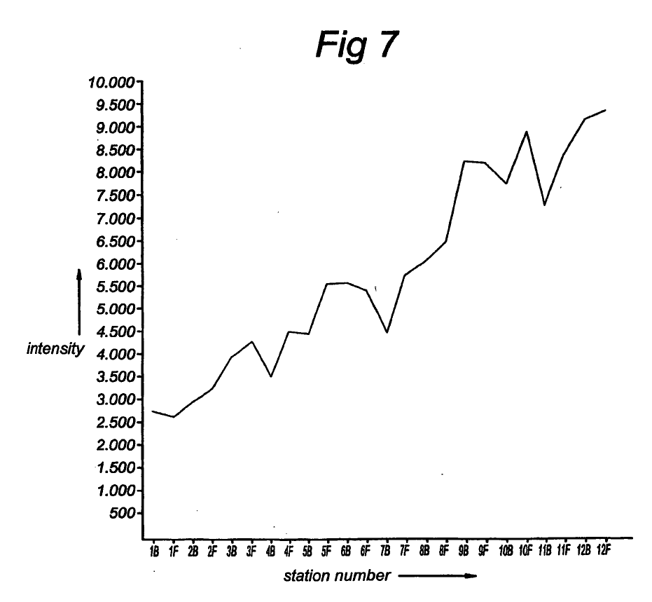

FIG. 7 is a graph of a so-called machine plot,

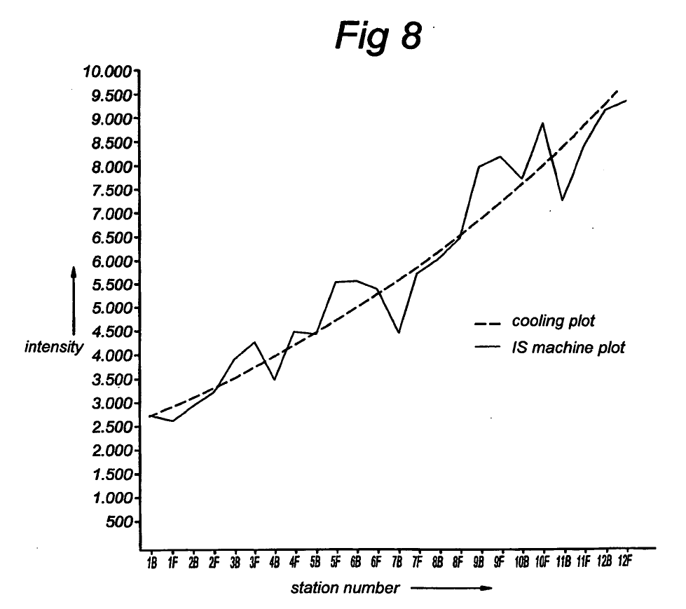

FIG. 8 is a graph of a so-called machine plot with a fit curve.

FIG. 1 shows a known production process for hollow glass products in which various process steps can be recognised. In a melting furnace 1 recycled glass fragments, mixed with basic raw material and additives, are remelted to give liquid glass. The molten glass flows from the melting furnace 1 via one or more channels 2 (“forehearth”) to a feeder 3. Downstream of the feeder 3 the stream of glass is cut into glass gobs in a gob forming process 4. The glass gobs are then fed via a gob transport 5 to an Independent Section (IS) machine 6.

The IS machine 6 in which the shaping process takes place is shown in more detail in FIG. 2. In the IS machine 6 each glass gob is shaped into a product. The shaping process is, for example, carried out with the aid of two moulds. The gob first falls into a first mould (the so-called blank mould 11) where, depending on the shaping process, the first stage of the product is blown or pressed. This first stage of the product, also termed the parison, is then transported to a second mould (the so-called blow mould 12), where the parison is blown to give the final shape of a glass product 18. The section 16 with the two moulds is also termed a station. The IS machine 6 consists of several parallel sections 14. Each section 14 can, in turn, consist of several stations 16 which are able to produce products independently of one another. The blown glass products 18 are placed one after the other on a conveyor belt 8 and fed to a cooling oven 7; see FIG. 1. In the cooling oven 7 the products are heated to above the so-called annealing point of the glass. The products are rendered stress-free by this means. The products can now cool and can be packed and transported to their destination. The section of the production process downstream of the cooling oven is also termed the “cold” section of the production area During production a wide variety of faults which have an adverse effect on the quality of the glass product can arise in every process step. Consequently it is necessary for the process variables of each process step to be set within very narrow tolerances and to be monitored. These process settings are dependent on the type of end product and have to be re-adjusted for the production of a different type of product (the so-called product change). An end product 18 of good quality has the correct dimensions, has a uniform glass thickness, does not have any cracks, has an even colour and has a high degree of glass purity. Glass purity means that the glass must be free from all sorts of material foreign to glass, such as grit, air bubbles, metals and contamination.

In order to be able to offer the customer glass products 18 of a consistently high quality, the glass products are inspected to determine their quality. To prevent information from the shaping process being lost by the annealing process, currently use is made of an infrared measurement system 20, see FIG. 2, which measures the thermal radiation by the glass product 18 before the glass product enters the cooling oven 7. The information obtained by the infrared measurement system 20 can be used to monitor the quality of the glass products 18 and the process. The known measurement system 20 has the disadvantages mentioned above.

FIG. 3 shows, diagrammatically, a novel measurement system 30 according to an embodiment of the invention. The measurement system 30 comprises a filter system 34, at least one infrared sensor 32 and a digital processor 38. The filter system 34 allows selective transmission only of infrared radiation in the Near Infra Red (NIR) region, that is to say radiation having a wavelength of between 600 and 5000 nanometres. Thermal radiation in the NIR region mainly originates from the interior of a glass wall 36. Preferably the filter system is so equipped that it allows the transmission of radiation in the wavelength range of 900 to 2800 nanometers, depending on the specific composition of the glass. In FIG. 3 the NIR radiation is shown by the thin dashed arrows. The digital processor 38 is equipped to analyse a heat distribution in a glass product on the basis of measurement data. This can take place in various ways, which are described in the embodiments below.

In one embodiment the digital processor 38 is equipped to subdivide the heat distribution obtained for a glass product into so-called measurement regions 40, 41, 42, 43, 44; see FIG. 4. These can be a number of strips that subdivide the image of the glass product 18 into horizontal measurement regions 40, 41, 42, 43, 44 (see FIG. 4), but a different form of measurement regions 40, 41, 42, 43, 44 is also possible. The number of measurement regions 40, 41, 42, 43, 44 is two or more. The number of measurement regions is not relevant, but more detailed information on the shaping process is obtained with a larger number of measurement regions. The measured intensities of the radiation are preferably averaged over each measurement region 40, 41, 42, 43, 44. The current average value thus obtained is compared with a reference value. This reference value is determined by the cooling curve originating from the measurement region or by another statistical calculation such as, for example, the running average. If the current average value is greater than the reference value the difference is ‘positive’; see FIG. 5. If the average value is lower than its reference value this difference is then ‘negative’.

This analysis is carried out for each measurement region 40, 41, 42, 43, 44 set. If there are measurement regions 40, 41, 42, 43, 44 that display a difference and have an opposite sign the change is to be ascribed to a change in the glass thickness; see FIG. 5. Explanation: each glass product is formed from a glass gob. The gobs have a constant weight and volume. The quantity of glass per product is thus constant. If, as a result of a disturbance in the process, a thinner glass wall is produced somewhere in the product, for example in the base section, the glass wall thickness in another measurement region 40, 41, 42, 43, 44 of the product then has to increase. The measurement regions 40, 41, 42, 43, 44 with a thinner glass wall will emit less radiation; the measurement regions 40, 41, 42, 43, 44 with a thicker glass wall will emit more radiation. The change cannot be ascribed to a change in the material properties since the glass for the products comes from the same furnace.

FIG. 6 shows a graph with a different change in the average intensity of the measurement regions 40, 41, 42, 43, 44. As a result of a disturbance in the process a deviation in the radiation occurs. Because in this case the measured deviation has a matching sign there has been a change in the glass wall temperature. Explanation: each glass product is formed from a glass gob. The gobs have a constant weight and volume. The quantity of glass per product is thus constant. If, as the result of a disturbance in the process, the temperature of the glass product 18 rises, those parts of the glass product 18 that are hotter will then all emit more radiation. Since the thickness of the glass wall has not changed, the deviations in the relevant measurement regions 40, 41, 42, 43, 44 will all have a matching sign for the difference. The change cannot be ascribed to a change in the material properties since the glass for the glass products 18 comes from the same melting furnace 1.

Each section 14 of the IS machine 6 consists of one or more stations 16. Each station 16 can produce a glass product 18 independently of the other sections 14. The glass products 18 that have just been formed are in a fixed sequence on the conveyor belt 8. Depending on the section 14 from which they have been produced, the glass products 18 all have a different cooling time. This is the time between the end of the shaping process and the time when the product passes by the measurement system 30.

Because the invention is preferably synchronised over time with the IS machine 6, the station 16 from which the glass product 18 originates is known for each glass product 18. In FIG. 7 the measured intensity is plotted against the various stations 16 for one specific measurement region 40, 41, 42, 43, 44. The names of the stations (B and F) associated with the various sections (‘1’, . . . ‘12’) are plotted along the X axis. Stations 16 that are closer to the measurement system 30 have a shorter cooling time and thus also have a higher radiation level at the point in time when they pass by the measurement system 30. Thus, it can be seen in FIG. 7 that a glass product 18 from station ‘12B’, which is close to the measurement system 30 (see also FIG. 2), is hotter than a glass product 18 from station ‘1B’, which is far away from the measurement system 30. The graph obtained is termed the IS machine plot.

In FIG. 8 an exponential curve that has been calculated with the aid of the “least squares” or a similar method has been drawn through the measurement points from FIG. 7. This curve is termed the cooling curve. If all glass products formed have the same glass wall thickness, temperature distribution and material characteristics after their final shaping process, the measurement points of the IS machine plot will then lie precisely on the cooling curve. The glass products 18 will all be of the same quality. If, however, a disturbance occurs in a process step for a specific section 14 (and thus station), the products originating from this section 14 will be affected by a change in quality. The temperature distribution and/or the glass wall thickness will change. As a result the IS machine plot will display a deviation with respect to the cooling curve. If the measured intensities are on the cooling curve, the glass products 18 will then be of the same quality. The conclusion is then also that the cooling curve can be used as a reference value for the shaping process. The values of IS machine setting parameters associated with a specific cooling curve for a glass product 18 can serve as reference values for the future production of the glass product 18.

When another type of glass product has to be produced, all setting parameters for the shaping process will then have to be adjusted. To appreciably shorten this adjustment time and to reduce the large amount of guesswork, the (already known) setting parameters from the cooling curve for the glass product are immediately used as reference value. The settings for the shaping process are now so adjusted that the IS machine plot becomes identical to the cooling curve. In this way all glass products 18 acquire the same quality as in the previous production.

By recording any deviations between a current IS machine plot and the cooling curve it is possible to indicate an error in the shaping process and to determine in which process step this error has occurred. Preferably, the IS machine plots and the cooling curves are determined for all set measurement regions 40, 41, 42, 43, 44 for the current process. The calculated cooling curves are used as reference values for each station. If a deviation occurs in the IS machine plot with respect to the cooling curve then the following situations can have arisen:

Situation A: The deviation applies to all sections and the new calculated cooling curves have been shifted up or down compared with the existing cooling curves, but the shape of the cooling curve has remained virtually the same.

Analysis A: A deviation has occurred for all sections. This means that a fault has occurred in the entire IS machine, such as, for example, the cooling capacity for all sections, or a fault has occurred in the process steps upstream of the IS machine in the feeder, forehearth and melting furnace. Furthermore, the fault is solely of a thermal nature.

Explanation: A station in a section can produce glass products 18 independently of other sections. If a deviating radiation pattern with respect to the cooling curve (the reference) is determined, the fault must then have been caused by a common factor. This is either a common factor in the IS machine 6 (such as the temperature, humidity of the cooling air in the IS machine 6) or a common factor in the process steps upstream of the IS machine 6. That is to say the temperature, material characteristics in the feeder, forehearth and melting furnace 1. The shape of the cooling curves has remained virtually the same. This means that the cooling rate of the products has also remained the same. It can thus be concluded that the initial temperature after the final production step in the IS machine 6 has increased or decreased for all sections 14 and that both the glass distribution and the material characteristics have remained the same.

Situation B: The deviation applies to all sections and the new calculated cooling curves have shifted up or down compared with the existing cooling curves but the shape of the cooling curve has also changed.

Analysis B: Once again there is a fault in all sections. Thus, the fault that has occurred must be a common factor. Because the shape of the cooling curves has changed, it can be concluded that the material characteristics of the glass have changed and that consequently the glass distribution has also changed.

Explanation: The shape of the cooling curves is dependent on the glass thickness of the glass wall and on the material characteristics but not on the initial temperature in the glass wall of the product. Since the quantity of glass remains virtually constant (gob), the deviation that has occurred simultaneously for all sections 14 must have been caused by a change in the material characteristics.

Situation C: A deviation occurs only for the stations 16 that have a common gob forming process.

Analysis C: If a deviation occurs in the IS machine plot compared with the cooling curve only for the stations 16 that have a common gob forming process, the disturbance is then caused in the gob forming process. If the average intensity of the stations with a deviation is higher or lower, the weight of the gob is then higher or lower.

Situation D: The deviation in the IS machine plot with respect to the cooling curve relates only to a single station 16.

Analysis D: A fault has occurred only in the station 16 concerned. Only those process components in the station can be the cause of the fault.

The embodiments described above are intended solely to serve as example and in no way are intended to limit the scope of the invention. A person skilled in the art will rapidly be able to devise other embodiments, such as, for example, the measurement of only a single bottle as a function of time so that a cooling curve can be obtained by this means. The IS machine 6 can also be made up of a different composition of sections 14 and stations 16, as a result of which the analytical methods proceed somewhat differently. It will also be clear to a person skilled in the art that the digital processor 38 can be replaced by any other suitable processor. The processor 38 can be constructed using analogue, digital or software techniques or any desired combination thereof. The processor 38 can also consist of various sub-processes, optionally in a master-slave relationship. The processor does not necessarily have to be close to the rest of the system but can, for example, communicate with the measurement system via remote communication.

1. Analytical system for analysing and controlling a production process for glass products, the production process comprising a shaping process and a cooling process and the analytical system comprising an infrared-sensitive measurement system and a processor communicating therewith, the infrared-sensitive measurement system being equipped to measure infrared radiation originating from hot glass products immediately after the shaping process for the glass products and the processor being equipped to determine a heat distribution in the glass products on the basis of information determined by the measurement system, characterised in that the infrared-sensitive measurement system (30) is sensitive only to radiation in the Near Infra Red (NIR) region.

2. Analytical system according to claim 1, characterised in that the infrared-sensitive measurement system (30) is sensitive to wavelengths of between 900 and 2800 nanometers.

3. Analytical system according to one of the preceding claims, characterised in that the infrared-sensitive measurement system (30) comprises at least one infrared sensor (32) and at least one Near Infra Red filter (34).

4. Analytical system according to claim 3, characterised in that the transmission characteristic of the Near Infra Red filter (34) is dependent on the colour and the specific material composition of the glass products.

5. Analytical system according to one of the preceding claims, characterised in that the processor (38) is equipped to carry out the following step:
(a) subdividing an image of the glass products (18) into at least two measurement regions (40, 41, 42, 43, 44).

6. Analytical system according to claim 5, characterised in that the processor (38) is equipped to carry out the following step:
(b) determining average intensity values for the different measurement regions for consecutive glass products (18).

7. Analytical system according to claim 6, characterised in that the processor (38) is equipped to carry out the following steps:
(c) determining, for at least two measurement regions, a current average value from the average intensity values determined for a number of consecutively shaped glass products (18) over time;
(d) recording, for each of the at least two measurement regions, any deviation between the current intensity or the current average intensity and a reference value;
(e) comparing any deviations between the at least two measurement regions;
(f) generating an error signal in the event of any deviations.

8. Analytical system according to claim 7, characterised in that the error signal is indicative of a deviating glass thickness if a positive deviation occurs in a first measurement region and a negative deviation occurs in a second measurement region.

9. Analytical system according to claim 7, characterised in that the error signal is indicative of a deviating glass temperature if a positive deviation occurs for all measurement regions or a negative deviation occurs for all measurement regions.

10. Analytical system according to claim 6, characterised in that the processor (38) is equipped to carry out the following steps for at least one measurement region:
(c) determining a machine plot by plotting a graph of the average intensity values as a function of the consecutive glass products (18), i.e. stations (14);
(d) determining a cooling plot by means of an optimum fit curve;
(e) recording any deviations between a current machine plot and the cooling plot;
(f) generating an error signal in the event of any deviations.

11. Analytical system according to claim 10, characterised in that the error signal contains information on a possible cause during the shaping process.

12. Analytical system according to claims 1-3, characterised in that the processor (38) is equipped to record local discontinuities in the heat distribution in a glass product.

13. Method for analysing and controlling a production process for glass products, comprising:
a) providing measurement means for determining a heat distribution in hot glass products;
b) measuring infrared radiation originating from the hot glass products before these enter a cooling oven;
c) determining a heat distribution in glass products on the basis of the infrared radiation measured,
characterised in that the measurement means (30) are sensitive only to radiation from the Near Infra Red region.

14. Method according to claim 13, characterised in that the measurement means (30) are sensitive only to wavelengths between 900 and 2800 nanometres.

15. Method according to claim 13, characterised in that the measurement means (30) comprise at least one infrared sensor (32) and at least one Near Infra Red filter (34).

16. Method according to one of claims 13-15, characterised in that the method comprises the following step:
(d) subdividing an image of the glass products (18) into at least two measurement regions (40, 41, 42, 43, 44).

17. Method according to one of claims 13-16, characterised in that the method comprises the following step:
(e) determining average intensity values for the different measurement regions for consecutive glass products (18).

18. Method according to one of claims 13-17, characterised in that the method comprises the following steps:
(f) determining, for at least two measurement regions, a current average value from the average intensity values determined for a number of consecutively shaped glass products (18);
(g) recording, for each of the at least two measurement regions, any deviation between the current average intensity and a reference value;
(h) comparing any deviations between the at least two measurement regions;
(i) generating an error signal in the event of any deviations.

19. Method according to claim 18, characterised in that the error signal is indicative of a deviating glass thickness if a positive deviation occurs in a first measurement region and a negative deviation occurs in a second measurement region.

20. Method according to claim 18, characterised in that the error signal is indicative of a deviating glass temperature if a positive deviation occurs for all measurement regions or a negative deviation occurs for all measurement regions.

21. Method according to claim 17, characterised in that the method comprises the following steps:
(j) determining a machine plot by plotting a graph of the average intensity values as a function of the consecutive glass products (18), i.e. stations (14);
(k) determining a cooling plot by means of an optimum fit curve;
(l) recording any deviations between a current machine plot and the cooling plot;
(m) generating an error signal in the event of any deviations.

22. Method according to one of claims 13-15, characterised in that the method comprises recording local discontinuities in the heat distribution in the glass product.
